(19) United States
(12) Patent Application Publication
(10) Pub. No.: US 2025/0296343 A1
(43) Pub. Date: Sep. 25, 2025

(54) LIQUID DISCHARGE HEAD, HEAD UNIT, AND LIQUID DISCHARGE APPARATUS

(71) Applicants: Yoshinori BANDOH, Kanagawa (JP); Takeshi SANO, Kanagawa (JP)

(72) Inventors: Yoshinori BANDOH, Kanagawa (JP); Takeshi SANO, Kanagawa (JP)

(21) Appl. No.: 19/077,284

(22) Filed: Mar. 12, 2025

(30) Foreign Application Priority Data
Mar. 22, 2024 (JP) 2024-046657

(51) Int. Cl. B41J 2/17; B41J 2/11; B41J 2/14

(52) U.S. Cl. CPC B41J 2/1714; B41J 2/11; B41J 2/14233; B41J 2202/11

(57) ABSTRACT

A liquid discharge head includes multiple nozzles arrayed in a first direction, the multiple nozzles to discharge droplets in a discharge direction onto a medium conveyed in a second direction intersecting the first direction, and a gas-discharge port between the multiple nozzles adjacent to each other in the first direction, the gas-discharge port to discharge gas.

### CROSS-REFERENCE TO RELATED APPLICATION

This patent application is based on and claims priority pursuant to 35 U.S.C. § 119 (a) to Japanese Patent Application No. 2024-046657, filed on Mar. 22, 2024, in the Japan Patent Office, the entire disclosure of which is hereby incorporated by reference herein.

### BACKGROUND

### Technical Field

The present disclosure relates to a liquid discharge head, a head unit, and a liquid discharge apparatus.

### Related Art

As a liquid discharge head to be mounted on an inkjet image forming apparatus, there is a liquid discharge head that includes multiple nozzles arranged side by side in a direction intersecting with a sheet conveyance direction.

Such a liquid discharge head is disadvantageous because an airflow generated by a droplet discharge from a nozzle causes a shift of a landing position of the droplet on a medium in a nozzle array direction. In particular, the liquid discharge head, having multiple nozzles arranged with high density, discharges droplets reduced in size to achieve high image quality, miniaturization, and high productivity. The landing position of the droplet discharge from the liquid discharge head with high-density nozzles tends to be significantly shifted in the nozzle array direction due to the airflow generated by a discharge of the droplet.

### SUMMARY

In an aspect of the present disclosure, a liquid discharge head is provided that includes multiple nozzles arrayed in a first direction, the multiple nozzles to discharge droplets in a discharge direction onto a medium conveyed in a second direction intersecting the first direction, and a gas-discharge port between the multiple nozzles adjacent to each other in the first direction, the gas-discharge port to discharge gas.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram of an image forming apparatus according to a first embodiment of the present disclosure;

FIG. 2 is a block diagram illustrating a control system of the image forming apparatus according to the first embodiment of the present disclosure;

FIG. 3 is an exploded perspective view of a liquid discharge head according to the first embodiment of the present disclosure;

FIG. 4 is a cross-sectional view of the liquid discharge head illustrated in FIG. 3, taken along a lateral direction;

FIG. 5 is a plan view of a head unit according to the first embodiment of the present disclosure, which illustrates a configuration of the head unit;

FIG. 6 is a plan view of a nozzle surface of the liquid discharge head according to the first embodiment of the present disclosure as viewed from a direction orthogonal thereto;

FIG. 7 is a schematic configuration diagram of a gas supply mechanism provided in the liquid discharge head according to the first embodiment of the present disclosure;

FIG. 8 is a diagram illustrating, in a cross section taken along line A-A in FIG. 6, a state in which gas is discharged from gas-discharge ports in the first embodiment of the present disclosure;

FIG. 9 is a diagram illustrating, in a cross section taken along line B-B in FIG. 6, a state in which gas is discharged from a gas-discharge port in the first embodiment of the present disclosure;

FIG. 10 is a diagram illustrating, in a cross section taken along a sheet conveyance direction, a state in which gas is discharged from a gas-discharge port in a second embodiment of the present disclosure;

FIG. 11 is a plan view of an exemplary serial-type head unit;

FIG. 12 is a cross-sectional view of a gas-discharge port provided in the serial-type head unit;

FIG. 13 is a diagram illustrating how gas flows when the liquid discharge head moves in one direction;

FIG. 14 is a diagram illustrating how gas flows when the liquid discharge head moves in an opposite direction;

FIG. 15 is a plan view of exemplary nozzle arrangement in which nozzles are aligned in both directions of the sheet conveyance direction and a direction intersecting with the sheet conveyance direction;

FIG. 16 is a schematic diagram illustrating an exemplary electrode manufacturing apparatus according to an embodiment of the present disclosure;

FIG. 17 is a diagram illustrating how air flows when a droplet is discharged to a sheet from one of nozzles of the liquid discharge head;

FIG. 18 is a diagram illustrating how air flows when droplets are consecutively discharged from one of the nozzles;

FIG. 19 is a diagram illustrating how air flows when droplets are consecutively discharged from each nozzle in a case where multiple nozzles is arranged in one direction;

FIG. 20 is a diagram illustrating how air flows when discharge of droplets is viewed from a nozzle array direction; and

FIG. 21 is a diagram illustrating a state in which airflows are generated in a region located on the inner side of a nozzle row.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure will be described with reference to the accompanying drawings. Referring now to the drawings, wherein like reference numerals designate identical or corresponding parts throughout the several views thereof, an image forming apparatus according to an embodiment of the present disclosure is described below.

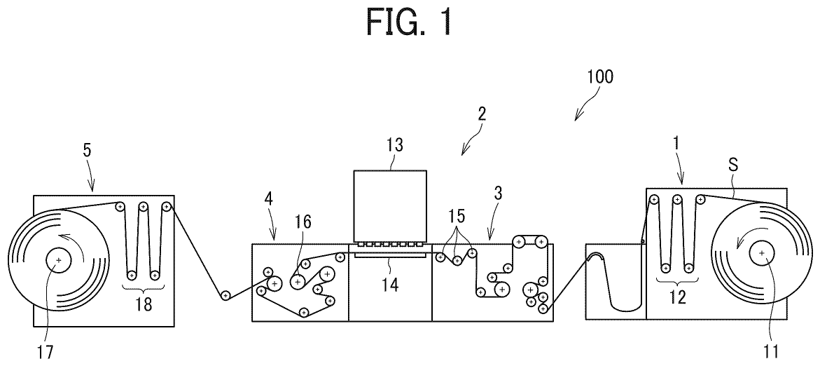

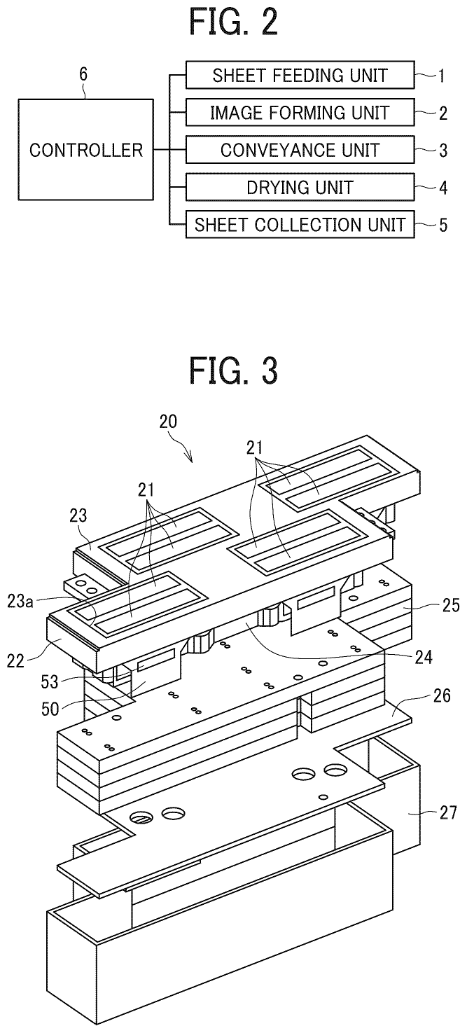

Overall Configuration of Image Forming Apparatus First, with reference to FIGS. 1 and 2, a description will be given of an overall configuration of an inkjet image forming apparatus that is an example of a liquid discharge apparatus.

FIG. 1 is a schematic configuration diagram of an image forming apparatus according to a first embodiment of the present disclosure. FIG. 2 is a block diagram illustrating a control system of the image forming apparatus according to the first embodiment of the present disclosure.

As illustrated in FIG. 1, an image forming apparatus 100 according to the first embodiment of the present disclosure includes a sheet feeding unit 1, an image forming unit 2, a conveyance unit 3, a drying unit 4, and a sheet collection unit 5. The sheet feeding unit 1 feeds a sheet S for image formation. The sheet S is an example of a medium on which an image is formed by the image forming apparatus 100.

The image forming unit 2 forms an image on the sheet S. The conveyance unit 3 conveys the sheet S to the image forming unit 2. The drying unit 4 dries the sheet S. The sheet collection unit 5 collects the sheet S on which an image has been formed. In addition, the image forming apparatus 100 according to the first embodiment of the present disclosure includes a controller 6 that controls the sheet feeding unit 1, the image forming unit 2, the conveyance unit 3, the drying unit 4, and the sheet collection unit 5 as illustrated in FIG. 2.

The sheet feeding unit 1 includes a feed roller 11 and a tension adjustment mechanism 12. The sheet S, which is a long sheet roll, is wound around the feed roller 11. The tension adjustment mechanism 12 adjusts tension to be applied to the sheet S. The feed roller 11 is rotatable in the direction of an arrow in FIG. 1, and the sheet S is fed out by rotation of the feed roller 11. The tension adjustment mechanism 12 includes a plurality of rollers that applies tension to the sheet S stretched over the plurality of rollers. Some of the plurality of rollers move to adjust the tension of the sheet S. Thus, the sheet S is fed from the feed roller 11 under a constant tension.

The image forming unit 2 includes a head unit 13 and a platen 14. The head unit 13 includes a plurality of liquid discharge heads that discharges droplets of ink or the like onto the sheet S. The platen 14 serves as a sheet supporting member that supports the sheet S being conveyed. An image is formed on the sheet S by a droplet discharged from each liquid discharge head onto the sheet S based on image data generated by the controller 6. The platen 14 is disposed in such a way as to face the head unit 13, and supports a lower surface of the sheet S fed from the sheet feeding unit 1. The platen 14 can move toward or away from the head unit 13 so that the distance between the head unit 13 and the sheet S can be kept constant.

A plurality of conveyance rollers 15 is provided in the conveyance unit 3. The sheet S is conveyed to the image forming unit 2 as each of the conveyance rollers 15 rotates when the sheet S is stretched over each of the conveyance rollers 15. Note that the conveyance unit 3 may include another conveyance means such as a conveyor belt.

The drying unit 4 includes a heating drum 16 that heats the sheet S. The heating drum 16 is a cylindrical member that rotates when the sheet S is wound around an outer circumferential surface of the heating drum 16. The heating drum 16 includes a heating source, such as a halogen heater, disposed therein. When the sheet S to which droplets have been applied is conveyed while being wound around the heating drum 16 in the image forming unit 2, the sheet S is heated, and drying of the sheet S is promoted. In addition to a contact type heating unit such as the heating drum 16, a non-contact type heating unit such as a hot air generator that blows hot air onto the sheet S can also be used as the heating unit that heats the sheet S.

The sheet collection unit 5 includes a collection roller 17 and a tension adjustment mechanism 18. The collection roller 17 winds and collects the sheet S. The tension adjustment mechanism 18 adjusts tension to be applied to the sheet S. The collection roller 17 is rotatable in the direction of an arrow in FIG. 1, and the sheet S is wound into a roll shape and collected as the collection roller 17 rotates. The tension adjustment mechanism 18 includes a plurality of rollers, as with the tension adjustment mechanism 12 of the sheet feeding unit 1. Some of the plurality of rollers move to adjust the tension of the sheet S. Thus, the sheet S is wound by the collection roller 17 under a constant tension.

The controller 6 includes an information processor such as a personal computer (PC). The controller 6 generates image data on an image to be formed on the sheet S. In addition, the controller 6 controls various types of operation of the sheet feeding unit 1, the image forming unit 2, the conveyance unit 3, the drying unit 4, and the sheet collection unit 5. For example, the controller 6 controls the temperature of the heating source that heats the heating drum 16, in addition to the speeds of rotation of the feed roller 11, the collection roller 17, and each conveyance roller 15.

### Configuration of Liquid Discharge Head

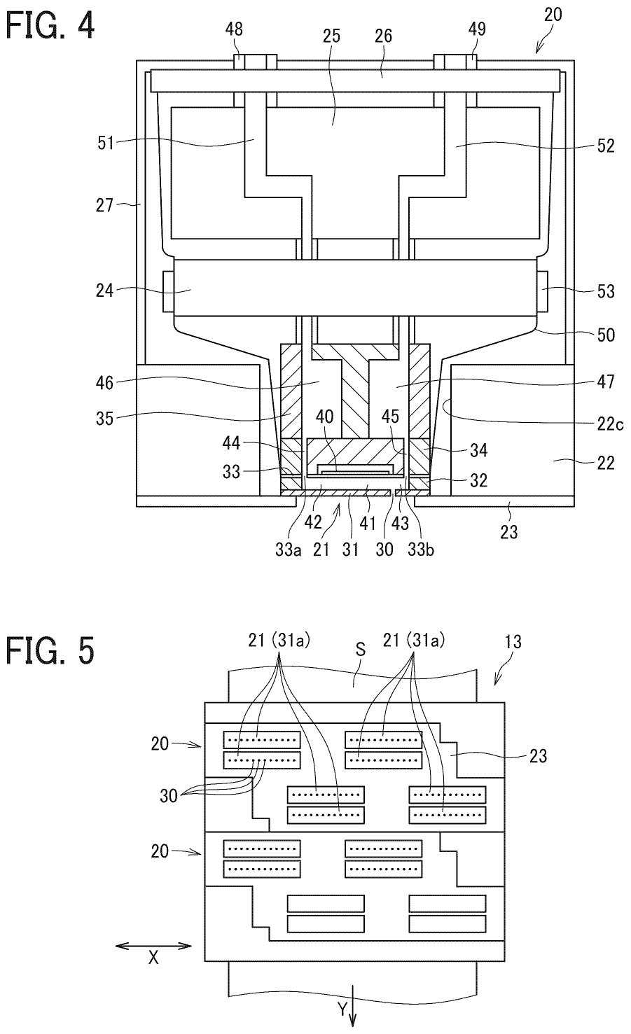

Next, a configuration of the liquid discharge head according to the first embodiment of the present disclosure will be described with reference to FIGS. 3 and 4.

FIG. 3 is an exploded perspective view of the liquid discharge head according to the first embodiment of the present disclosure. FIG. 4 is a cross-sectional view of the liquid discharge head illustrated in FIG. 3, taken along a lateral direction.

As illustrated in FIG. 3, a liquid discharge head 20 according to the first embodiment of the present disclosure includes a plurality of head bodies 21, a base member 22, a cover member 23, a heat dissipation member 24, a manifold 25, a printed circuit board (PCB) 26, and a module case 27.

The plurality of head bodies 21 is held by the base member 22 serving as a holding member. To attach the head body 21 to the base member 22, first, the head body 21 is inserted into an opening 22c (see FIG. 4) provided in the base member 22. Next, the head body 21 is joined to the cover member 23 joined to the base member 22. A hole 23a (see FIG. 3) corresponding to each head body 21 is formed in the cover member 23, and a peripheral edge portion of the head body 21 is joined to an edge of the hole 23a. The head body 21 is secured by being fastened to the base member 22 with a screw. Specifically, flange portions of a common channel member 35 (see FIG. 4) are provided on the front side and the back side in a longitudinal direction of the head body 21 (direction orthogonal to the plane of FIG. 4), and the flange portions are fastened to the base member 22 with screws. Accordingly, the common channel member 35 is held by the base member 22, and the head body 21 is secured. The structure of attaching the head body 21 to the base member 22 is not limited thereto, and the head body 21 may be attached by adhesion, caulking, or the like.

As illustrated in FIG. 4, the head body 21 includes a nozzle plate 31, a channel substrate 32, a diaphragm 33, a holding substrate 34, the common channel member 35, and the like. The nozzle plate 31 has a nozzle 30 provided therein. An individual liquid chamber 41 leading to the nozzle 30 is formed in the channel substrate 32. The diaphragm 33 includes a piezoelectric element 40. The holding substrate 34 is placed as a layer on the diaphragm 33. The common channel member 35 serves as a frame member placed as a layer on the holding substrate 34.

In addition to the individual liquid chamber 41, a supply-side individual channel 42 communicating with the individual liquid chamber 41 and a collection-side individual channel 43 communicating with the individual liquid chamber 41 are formed in the channel substrate 32. A supply-side intermediate individual channel 44 and a collection-side intermediate individual channel 45 are formed in the holding substrate 34. The supply-side intermediate individual channel 44 communicates with the supply-side individual channel 42 via an opening 33a of the diaphragm 33. The collection-side intermediate individual channel 45 communicates with the collection-side individual channel 43 via another opening, that is, an opening 33b of the diaphragm 33.

A supply-side common channel 46 and a collection-side common channel 47 are formed in the common channel member (frame member) 35. The supply-side common channel 46 communicates with the supply-side intermediate individual channel 44. The collection-side common channel 47 communicates with the collection-side intermediate individual channel 45. The supply-side common channel 46 communicates with a supply port 48 via a channel 51 of the manifold 25. Meanwhile, the collection-side common channel 47 communicates with a collection port 49 via another channel, that is, a channel 52 of the manifold 25.

The printed circuit board 26 and the piezoelectric element 40 of the head body 21 are connected via flexible wiring members 50. A driver integrated circuit (IC) (drive circuit) 53 is mounted on each flexible wiring member 50.

The base member 22 is preferably made of a material having a small coefficient of linear expansion. Examples of the material having a small coefficient of linear expansion include 42alloy, which is obtained by addition of nickel to iron, and an invar material. In a case where the base member 22 is made of such a material, the amount of expansion of the base member 22 is small even if the base member 22 increases in temperature due to heat generation of the liquid discharge head 20. Therefore, positional displacement of the nozzles is less likely to occur. It is thus possible to prevent ink discharge positions from being shifted. Furthermore, it is possible to further reduce the positional displacement of the nozzles due to thermal expansion by using the nozzle plate 31 and the diaphragm 33 made of a silicon single crystal substrate so that the coefficients of linear expansion of the nozzle plate 31 and the diaphragm 33 are substantially equal to the coefficient of linear expansion of the base member 22.

FIG. 5 is a plan view of the head unit 13 according to the first embodiment of the present disclosure, which illustrates a configuration of the head unit 13;

As illustrated in FIG. 5, the head unit 13 according to the first embodiment of the present disclosure includes two liquid discharge heads 20. When viewed from a direction orthogonal to a nozzle surface 31a having the nozzles 30, each liquid discharge head 20 is disposed such that short sides of the liquid discharge head 20 extend in a sheet conveyance direction Y and long sides of the liquid discharge head 20 extend in a direction X orthogonal to the sheet conveyance direction Y. Furthermore, multiple nozzles 30 is arranged side by side in the longitudinal direction of the liquid discharge head 20, that is, the direction X orthogonal to the sheet conveyance direction Y.

The head unit 13 according to the first embodiment of the present disclosure is a so-called line-type head unit. In this case, when the sheet S is conveyed in the direction of arrow Y in FIG. 5 to reach an image forming position facing the head unit 13, droplets are discharged from the head unit 13. At this time, droplets are discharged from the nozzles 30 of each of the head bodies 21 while the head unit 13 is not in motion relative to the sheet S being conveyed. As a result, an image is formed on the sheet S.

Issue of Shift in Position where Droplet is Applied

Meanwhile, an image forming apparatus including a head unit that discharges a droplet is disadvantageous in that when a droplet is discharged from a nozzle, a position where the droplet is applied is shifted due to an airflow generated along with droplet discharge. Hereinafter, a detailed description will be given of a mechanism for causing the position where a droplet is applied to be shifted at the time of droplet discharge.

First, a mechanism for generating an airflow as a result of droplet discharge will be described.

FIG. 17 is a diagram illustrating how air flows (airflows 9) when a droplet 10 is discharged to the sheet S from one of nozzles 300 of a liquid discharge head 200. In FIG. 17, an arrow outline with a blank inside indicates a direction in which the droplet 10 is discharged, and black arrows indicate directions of the airflows (airflows 9).

As illustrated in FIG. 17, when a single droplet 10 is discharged from the nozzle 300, the droplet 10 is decelerated by air resistance. At this time, the momentum of the droplet 10 decreases, and in contrast, the momentum of air increases by the amount of decrease in the momentum of the droplet 10. Accordingly, the air moves in a direction in which the droplet 10 is discharged. As a result, the amount of air decreases in the vicinity of the nozzle 300. Therefore, the airflow 9 directed from the periphery of the nozzle 300 toward the nozzle 300 is generated in the vicinity of the nozzle 300 so as to compensate for the decrease in the amount of air. Furthermore, since the air moves as a result of discharge of the droplet 10, the amount of air increases on the sheet S side, contrary to the nozzle 300 side. Therefore, in order to reduce the increase in the amount of air, airflows 9 are generated in a direction away from a position where the droplet 10 is applied.

FIG. 18 is a diagram illustrating how air flows (airflows 9) when droplets 10 are consecutively discharged from one of the nozzles 300.

As illustrated in FIG. 18, when the droplets 10 are consecutively discharged from the nozzle 300, the airflows 9 are continuously generated by the above mechanism. Then, when the discharge of the droplets 10 is continued for a certain period of time, the airflow 9 on the nozzle 300 side and the airflow 9 on the sheet S side are joined to generate a circulating airflow 9.

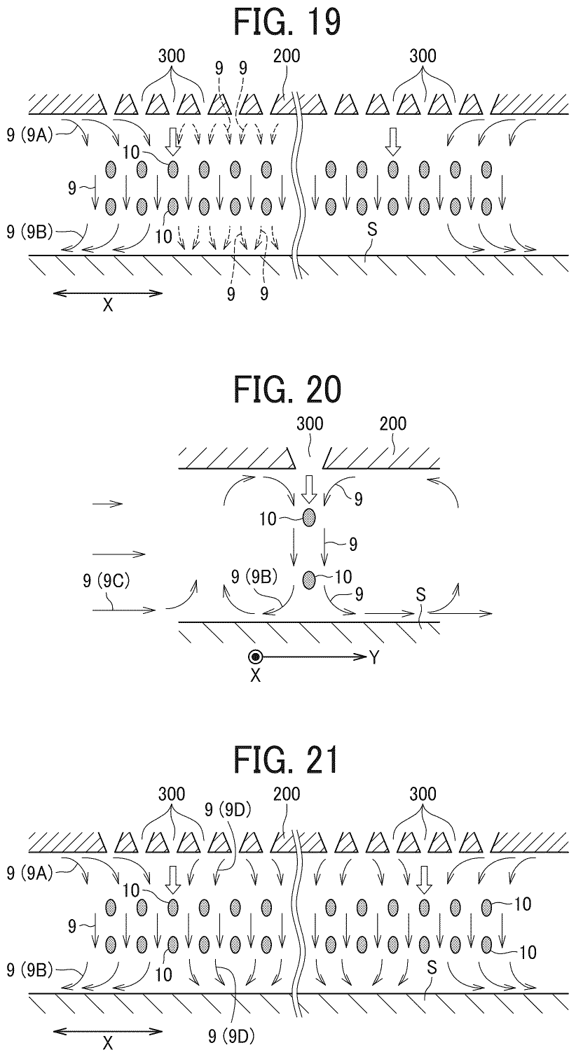

FIG. 19 is a diagram illustrating how air flows (airflows 9) when the droplets 10 are consecutively discharged from each nozzle 300 in a case where multiple nozzles 300 is arranged in one direction (direction of arrow X).

As illustrated in FIG. 19, when the droplets 10 are consecutively discharged from the multiple nozzles 300, airflows 9 indicated by broken line arrows in the drawing are generated in the vicinity of each nozzle 300 and on the sheet S side. Here, the airflow 9 generated between the nozzles 300 adjacent to each other is offset by an adjacent airflow 9. Therefore, the airflow 9 that affects the position where the droplet 10 is applied is hardly generated in a region located on the inner side of a nozzle row. Meanwhile, no nozzle 300 is located on the outer sides of both ends of the nozzle row. Therefore, the airflows 9 are not offset by adjacent airflows 9, and the airflows 9 are generated as indicated by solid arrows in the drawing. That is, an airflow 9 (9A) directed from the outer side to the inner side of the nozzle row is generated at each of the nozzles 300 located at both ends of the nozzle row, and an airflow 9 (9B) directed from each end of the nozzle row to the outer side is generated on the sheet S side. Therefore, at both ends of the nozzle row, a position where a droplet is applied is shifted in the nozzle array direction X as the droplet 10 is affected by the airflow 9 (9A, 9B).

FIG. 20 is a diagram illustrating how air flows (airflows 9) when discharge of the droplets 10 is viewed from the nozzle array direction (X direction).

As illustrated in FIG. 20, when the sheet S is conveyed in a direction (direction of arrow Y) orthogonal to the nozzle array direction X, an airflow 9 (9C) is generated in the sheet conveyance direction Y orthogonal to the nozzle array direction X, along with the conveyance of the sheet S. Therefore, on a side upstream of the nozzle 300 in the sheet conveyance direction Y, the airflow 9 (9B) generated on the sheet S side along with the discharge of the droplets 10 collides with the airflow 9 (9C) moving in the sheet conveyance direction Y. Then, since a part of the airflow generated by the collision is returned toward the droplet 10 by the airflow (9C) moving in the sheet conveyance direction Y, an airflow 9 (9D) moving in the nozzle array direction X may be generated also in the region located on the inner side of the nozzle row as illustrated in FIG. 21 due to the influence of the airflow. Generation of the airflow 9 (9D) may occur in the region located on the inner side of the nozzle row not only in a case where the nozzle array direction X and the sheet conveyance direction Y are orthogonal to each other, but also in a case where the nozzle array direction X and the sheet conveyance direction Y intersect with each other at an angle other than right angles.

The droplets 10 are not necessarily discharged from all the nozzles 300 during droplet discharge operation. Therefore, when no droplet 10 is discharged from some of the nozzles 300, the airflow 9 (9D) similar to the airflow 9 (9D) indicated in FIG. 21 may be generated. That is, when any of the nozzles 300 in the nozzle row discharges no droplet 10, the airflows 9 are not offset by adjacent airflows 9. Therefore, the state of the inner region of the nozzle row becomes similar to the state of both ends of the nozzle row, so that the airflow 9 (9D) moving in the nozzle array direction X may be generated.

As described above, in the configuration in which the multiple nozzles 300 is arranged in the direction X orthogonal to or intersecting with the sheet conveyance direction Y, when the droplets 10 are discharged from the nozzles 300 onto the sheet S, the airflow 9 (9A, 9B) moving in the nozzle array direction X is generated at least at both ends of the nozzle row, and the airflow 9 (9D) moving in the nozzle array direction X is also generated in the inner region of the nozzle row in some cases. As a result, the discharged droplets 10 are affected by the airflow 9 (9A, 9B, 9D) moving in the nozzle array direction X, and the positions where the droplets 10 are applied are shifted in the nozzle array direction X. Furthermore, depending on discharge conditions for each image to be formed, the volume of the discharged droplet 10 also changes in addition to a combination of the nozzles 300 that discharge (or do not discharge) the droplets 10. Thus, the airflow 9 generated along with the discharge of the droplets 10 also changes. Therefore, the position where the droplet 10 is applied also varies as a result of the droplet 10 being affected by the airflow 9.

Therefore, in order to effectively prevent a position where a droplet is applied from being shifted in the nozzle array direction, the following liquid discharge head is proposed in the present embodiment. A description will be given below of distinctive features of the present disclosure based on the first embodiment of the present disclosure taken as an example.

### Distinctive Features of Present Disclosure

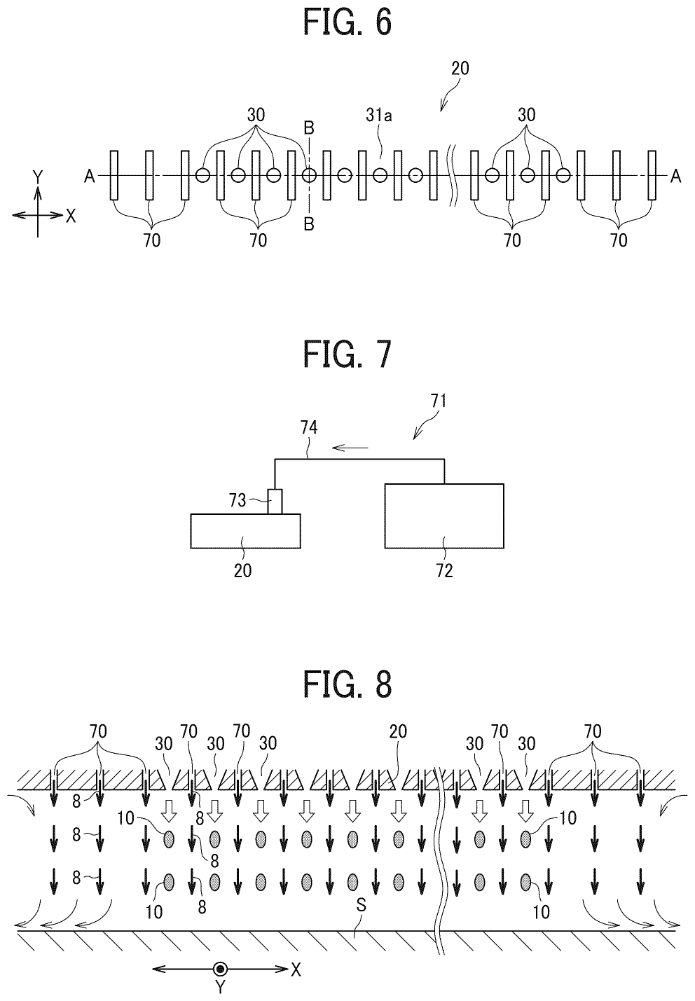

FIG. 6 is a plan view of the nozzle surface 31a of the liquid discharge head 20 according to the first embodiment of the present disclosure as viewed from a direction orthogonal thereto.

As illustrated in FIG. 6, in the liquid discharge head 20 according to the first embodiment of the present disclosure, the multiple nozzles 30 is arranged such that the nozzles 30 are aligned in the direction X intersecting with the sheet conveyance direction Y. Here, when a “first direction” is defined as the nozzle array direction X in which the multiple nozzles 30 is arranged, and a “second direction” is defined as a relative movement direction Y in which the sheet S and the nozzles 30 move relative to each other during droplet discharge, the “first direction” and the “second direction” are orthogonal to each other in the first embodiment of the present disclosure. In this case, the relative movement direction Y in which the sheet S and the nozzles 30 move relative to each other during droplet discharge refers to the sheet conveyance direction Y in which the sheet S is conveyed.

In the liquid discharge head 20 according to the first embodiment of the present disclosure, a gas-discharge port 70 out of which gas is to be jetted is disposed between the multiple nozzles 30 arranged in the nozzle array direction X (first direction) and also disposed on the outer side of each of outermost nozzles 30 in the nozzle array direction X, that is, each of the nozzles 30 at both ends.

FIG. 7 is a schematic configuration diagram of a gas supply mechanism provided in the liquid discharge head 20 according to the first embodiment of the present disclosure.

As illustrated in FIG. 7, a gas supply mechanism 71 includes a gas supply unit 72 and a supply pipe 74. The gas supply unit 72 supplies gas. The supply pipe 74 connects a gas supply port 73 provided in the liquid discharge head 20 to the gas supply unit 72. The gas supply port 73 communicates with a multiple gas-discharge ports 70 provided in the liquid discharge head 20. Therefore, when gas is supplied from the gas supply unit 72 to the liquid discharge head 20 via the supply pipe 74 and the gas supply port 73, the gas is discharged from each gas-discharge port 70. The gas to be discharged from the gas-discharge port 70 may be air, or may be a gas other than air. The gas supply unit 72 at least has a function of adjusting the amount of gas supply. Furthermore, the gas supply unit 72 preferably has a function of reducing fluctuations in the amount of gas supply and a function of enabling gas to be supplied and stopped as necessary.

FIG. 8 is a diagram illustrating, in a cross section taken along line A-A (nozzle array direction X) in FIG. 6, a state in which gas 8 is discharged from the gas-discharge ports 70 in the first embodiment of the present disclosure.

As illustrated in FIG. 8, when the droplets 10 are discharged from the multiple nozzles 30, air around the droplets 10 moves in a droplet discharge direction along with the discharge of the droplets 10 as described above. At this time, although the amount of air in the vicinity of the nozzle 30 decreases due to movement of the air, the flow of air is reduced in the vicinity of the nozzle 30 by the gas 8 discharged from the gas-discharge port 70. That is, an equal amount of gas 8 is supplied in compensation for the decrease in the amount of air. As a result, the flow of air from the periphery of the nozzle 30 toward the nozzle 30 is hindered. This prevents the airflow 9 (9A) moving in the nozzle array direction X from the outer side to the inner side of the nozzle row from being generated at the nozzles 30 located at both ends as illustrated in FIG. 19 or 21. In addition, since the gas 8 is jetted from both sides of each single nozzle 30, even if the droplet 10 is not discharged from the nozzle 30 adjacent to a certain nozzle 30 or the volume of the droplet 10 discharged from the adjacent nozzle 30 changes, the influence of the airflow changed depending on whether a droplet is discharged or changed along with the change in the droplet volume is reduced. This also prevents generation of the airflow 9 (9D) moving in the nozzle array direction X in the region located on the inner side of the nozzle row as illustrated in FIG. 21.

As described above, the gas 8 is discharged from the gas-discharge port 70 at the time of droplet discharge in the first embodiment of the present disclosure. It is thus possible to prevent the airflow 9 (9A) moving in the nozzle array direction X from the outer side to the inner side of the nozzle row from being generated at the nozzles 30 located at both ends as illustrated in FIG. 19 or 21 and prevent the airflow 9 (9D) in the nozzle array direction X from being generated in the region located on the inner side of the nozzle row as illustrated in FIG. 21. Therefore, according to the configuration of the first embodiment of the present disclosure, it is possible to effectively prevent a position where a droplet is applied from being shifted in the nozzle array direction X. It is thus possible to improve accuracy of causing the droplet 10 to be applied to a desired position.

The airflow 9 (9A, 9D) moving in the nozzle array direction X may be generated not only in a case where the nozzle array direction X is orthogonal to the sheet conveyance direction Y but also in a case where the nozzle array direction X and the sheet conveyance direction Y intersect with each other at an angle other than right angles. Therefore, the present embodiment is also applicable to the case where the nozzle array direction X and the sheet conveyance direction Y intersect with each other at an angle other than right angles. Therefore, the nozzle array direction X (first direction) and the relative movement direction Y (second direction), in which the sheet S and the nozzles 30 move relative to each other during droplet discharge, not only may be orthogonal to each other but also may intersect with each other at an angle other than right angles.

Furthermore, in the first embodiment of the present disclosure, the gas-discharge port 70 is disposed not only between the multiple nozzles 30 but also disposed on the outer side of each of the nozzles 30 at both ends. Thus, the airflows 9 (9B) directed outward from both ends of the nozzle row as illustrated in FIG. 19 or 21 are also prevented from being generated on the sheet S side. As a result, it is also possible to effectively prevent a position where a droplet is applied from being shifted at both ends of the nozzle row. In particular, when a multiple gas-discharge ports 70 is disposed on the outer side of each of the nozzles 30 at both ends as in the first embodiment of the present disclosure, it is also possible to more effectively prevent a position where the droplet 10 is applied from being shifted at both ends of the nozzle row. That is, when a multiple gas-discharge ports 70 is disposed on the outer side of each of the nozzles 30 at both ends, it is possible to cause a position where the airflow 9 (9B) directed outward from each end of the nozzle row is generated on the sheet S side to be shifted from the position of each of the nozzles 30 at both ends to the outer side of each of the nozzles 30 at both ends. As a result, generation of the airflow 9 (9B) directed outward is prevented at both ends of the nozzle row. Thus, it is possible to improve accuracy of causing the droplet 10 to be applied to a desired position. In the example of FIG. 6, three gas-discharge ports 70 are disposed on the outer side of each of the nozzles 30 at both ends, but one or two gas-discharge ports 70 may be disposed on the outer side of each of the nozzles 30 at both ends. Alternatively, four or more gas-discharge ports 70 may be disposed on the outer side of each of the nozzles 30 at both ends.

The number of gas-discharge ports 70 to be disposed between adjacent nozzles 30 can also be appropriately changed. Therefore, the gas-discharge port 70 may be simply disposed between the multiple nozzles 30 arranged in a direction orthogonal to or intersecting with the sheet conveyance direction Y. Alternatively, at least one gas-discharge port 70 may be disposed between the multiple nozzles 30. Meanwhile, the gas-discharge port 70 is preferably disposed between all the multiple nozzles 30 arranged in the nozzle array direction X (first direction) as illustrated in FIG. 6. In this case, since the gas 8 is jetted from both sides of the nozzles 30 that discharge the droplets 10 even if no droplet 10 is discharged from some of the multiple nozzles 30, it is possible to reduce the influence of the airflow 9 changed depending on whether a droplet is discharged. Thus, variation in a position where a droplet is applied can be reduced.

Furthermore, in order to reduce the influence of the airflow 9 changed depending on whether a droplet is discharged, it is preferable to perform control so that the gas 8 is constantly jetted during the droplet discharge operation or sheet conveyance operation. In this case, the gas 8 is constantly jetted even if the droplets 10 stop being discharged from some of the nozzles 30 during the droplet discharge operation or sheet conveyance operation, or instead, the droplets 10 start to be discharged from some of the nozzles 30. As a result, it is possible to reduce the influence of the airflow changed depending on whether a droplet is discharged. It is thus possible to improve accuracy of causing the droplet 10 to be applied to a desired position.

In order to reduce the influence of the airflow 9 changed depending on whether a droplet is discharged, it is preferable to reduce the difference between a speed at which the droplet 10 is discharged from the nozzle 30 and a speed (speed in a discharge direction) at which the gas 8 is discharged from the gas-discharge port 70. Since the influence of the discharge of the droplets 10 on the surrounding air is proportional to the difference between the speed (speed in the discharge direction) at which the droplet 10 is discharged and the speed of the airflow (gas 8), an average speed at which the gas 8 is jetted is preferably at the same level as an average speed at which the droplet 10 is discharged. Here, the speed at which the droplet 10 is discharged varies depending on the value of frequency at which the nozzles 30 are opened and closed, and also varies between the nozzles 30. Therefore, in consideration of general variations in the speed at which the droplet 10 is discharged, it is preferable to adjust the speed at which the gas 8 is jetted such that the average speed at which the droplet 10 is discharged falls within a range of plus or minus 20% of the average speed at which the gas 8 is jetted. The average speed at which the droplet 10 is discharged varies depending on the specifications of the liquid discharge head 20, but is generally about 5 m/s or more and 10 m/s or less. Thus, the average speed at which the gas 8 is jetted is preferably 4 m/s or more and 12 m/s or less. The average speed at which the droplet 10 is discharged here refers to a value obtained from a distance in the droplet discharge direction between the nozzle 30 and the sheet S divided by time from when the droplet 10 is discharged to when the droplet 10 reaches the sheet S.

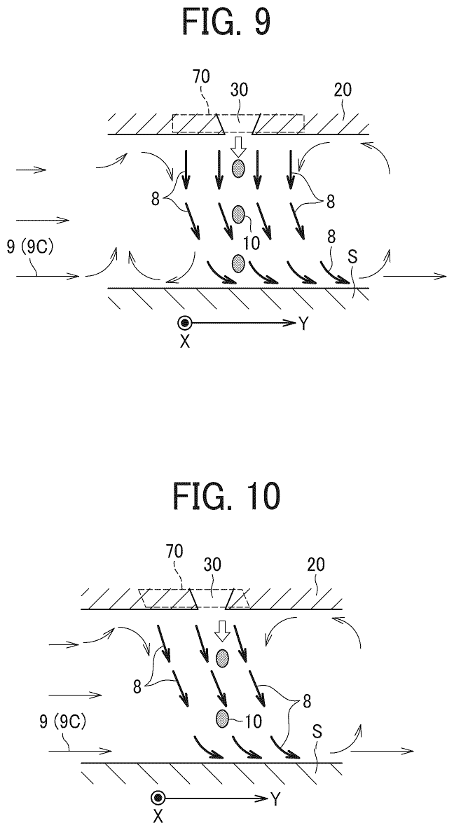

FIG. 9 is a diagram illustrating, in a cross section taken along line B-B (sheet conveyance direction Y) in FIG. 6, a state in which the gas 8 is discharged from the gas-discharge port 70 in the first embodiment of the present disclosure.

As illustrated in FIG. 9, in the first embodiment of the present disclosure, the gas-discharge port 70 is formed in such a way as to elongate in the sheet conveyance direction Y (second direction) as compared with the nozzle 30. When a “positive side” is defined as the downstream side of the nozzle 30 in the sheet conveyance direction Y, and a “negative side” is defined as the upstream side of the nozzle 30 in the sheet conveyance direction Y, the gas-discharge port 70 extends from the position of the nozzle 30 to both the positive side and the negative side in the sheet conveyance direction Y (second movement direction).

As described above, the gas-discharge port 70 extends to both the downstream side (positive side) and the upstream side (negative side) from the position of the nozzle 30 in the sheet conveyance direction Y in the first embodiment of the present disclosure. Therefore, when the nozzle 30 is viewed from the nozzle array direction X as illustrated in FIG. 9, the gas 8 is jetted not only from a position corresponding to the nozzle 30 (overlapping position) but also from positions on the upstream side and the downstream side of the position corresponding to the nozzle 30. Here, the jetted gas 8 is affected by the airflow 9 (9C) moving in the sheet conveyance direction Y and flows to the downstream side in the sheet conveyance direction Y, but the gas 8 jetted from the upstream side of the position of the nozzle 30 flows to a position where a droplet is applied and in the vicinity thereof even if the gas 8 is caused to flow to the downstream side in the sheet conveyance direction Y. Therefore, generation of the airflow 9 in the nozzle array direction X is prevented by the gas 8 flowing to the position where a droplet is applied and in the vicinity thereof. As a result, it is possible to effectively prevent the position where a droplet is applied from being shifted in the nozzle array direction X. In addition, since such an effect is obtained particularly by the gas 8 jetted from the upstream side of the position of the nozzle 30, the gas-discharge port 70 may be provided in such a way as to extend simply to the upstream side from the position of the nozzle 30 in the sheet conveyance direction Y.

Next, another embodiment of the present disclosure will be described. In the following description, differences from the first embodiment of the present disclosure will be mainly described, and description of the same portions will be omitted as appropriate.

### Second Embodiment of Present Disclosure

FIG. 10 is a diagram illustrating, in a cross section taken along the sheet conveyance direction Y, a state in which the gas 8 is discharged from the gas-discharge port 70 in a second embodiment of the present disclosure.

In the second embodiment of the present disclosure, when the gas-discharge port 70 is viewed from the nozzle array direction X as illustrated in FIG. 10, the discharge direction in which the gas 8 is discharged from the gas-discharge port 70 is inclined toward the downstream side in the sheet conveyance direction Y with respect to the direction in which the droplet 10 is discharged from the nozzle 30. Meanwhile, in the first embodiment of the present disclosure, the discharge direction in which the gas 8 is jetted is identical to the direction in which the droplet 10 is discharged (see FIG. 9).

In the first embodiment of the present disclosure, the discharge direction in which the gas 8 is jetted is identical to the direction in which the droplet 10 is discharged. Therefore, a part of the gas 8 jetted onto the sheet S is directed to the upstream side in the sheet conveyance direction Y and collides with the airflow 9 (9C) moving in the sheet conveyance direction Y as illustrated in FIG. 9. A part of the airflow generated by the collision is returned toward the droplet 10 by the airflow (9C) moving in the sheet conveyance direction Y. This may cause the airflow 9 (9D) moving in the nozzle array direction X to be generated in the region located on the inner side of the nozzle row as illustrated in FIG. 21 particularly when the gas 8 is strongly jetted.

Meanwhile, in the second embodiment of the present disclosure, the discharge direction in which the gas 8 is jetted is inclined toward the downstream side in the sheet conveyance direction Y with respect to the direction in which the droplet 10 is discharged from the nozzle 30. Therefore, the gas 8 jetted onto the sheet S is prevented from moving toward the upstream side in the sheet conveyance direction Y. As a result, collision between the gas 8 and the airflow 9 (9C) moving in the sheet conveyance direction Y can be avoided or prevented on the upstream side of the position where the droplet 10 is applied in the sheet conveyance direction Y. Thus, it is possible to more reliably prevent generation of the airflow 9 (9D) in the nozzle array direction X in the region located on the inner side of the nozzle row as illustrated in FIG. 21. Therefore, according to the second embodiment of the present disclosure, the gas 8 can be more strongly jetted, and it is possible to more effectively prevent generation of the airflow 9 in the nozzle array direction X. Thus, accuracy of causing the droplet 10 to be applied to a desired position can be expected to be further improved.

Although the embodiments of the present disclosure have been described above, the present disclosure is not limited to the above-described embodiments, and can be appropriately changed without departing from the gist of the invention.

In the above embodiments, a line-type head unit has been described as an example of the head unit according to the present disclosure. Meanwhile, the present disclosure is applicable not only to the line-type head unit but also to a so-called serial-type head unit that discharges ink while moving a liquid discharge head in the main scanning direction (sheet width direction). Hereinafter, an example in which the present disclosure is applied to a serial-type head unit will be described.

### Configuration of Serial-Type Head Unit

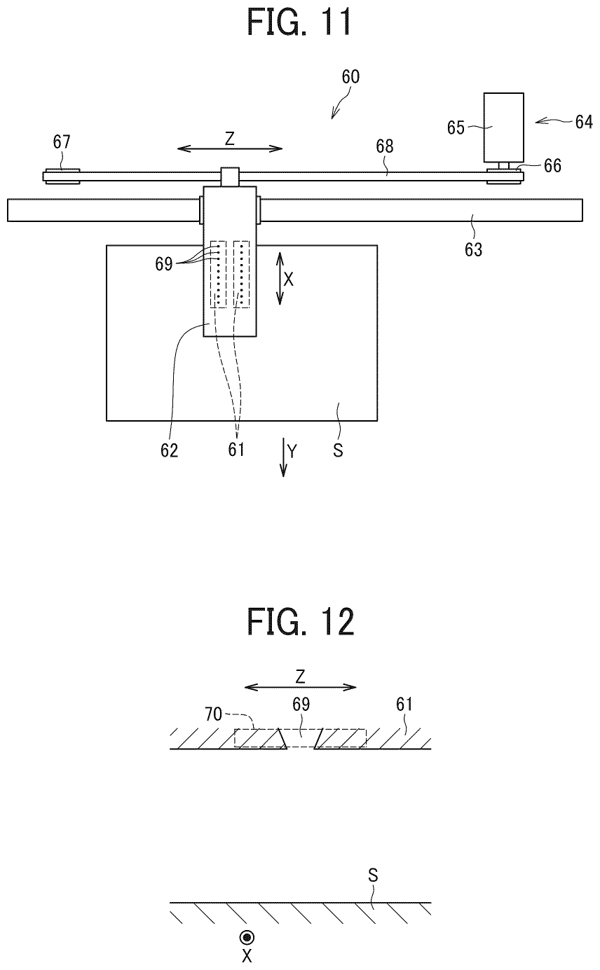

FIG. 11 is a plan view of an exemplary serial-type head unit.

A serial-type head unit 60 illustrated in FIG. 11 includes a carriage 62, a guide member (guide rod) 63, and a drive device 64. The carriage 62 has a liquid discharge head 61 mounted thereon. The guide member 63 is for guiding the carriage 62 in a main scanning direction Z which is the sheet width direction. The drive device 64 causes the carriage 62 to move.

The drive device 64 includes, for example, a motor 65 and a timing belt 68. The motor 65 serves as a driving source. The timing belt 68 is wound around a driving pulley 66 and a driven pulley 67. When the motor 65 is driven to rotate the driving pulley 66, the timing belt 68 rotates. As a result, the carriage 62 moves in the main scanning direction along the guide member 63. It is possible to cause the carriage 62 to reciprocate in the main scanning direction Z by switching directions of rotation of the motor 65 from one direction to the opposite direction.

As illustrated in FIG. 11, when the sheet S is conveyed in the direction of arrow Y to reach a predetermined image forming position, droplets (ink) are discharged from the liquid discharge head 61 while the carriage 62 is moving in the main scanning direction Z. As a result, an image is formed for a single row on the sheet S not being conveyed. Thereafter, movement and cessation of movement of the sheet S in the direction of arrow Y, reciprocation of the liquid discharge head 61 (carriage 62), and discharge operation of the liquid discharge head 61 are repeatedly performed. As a result, an image is sequentially formed on the sheet S.

In this case, multiple nozzles 69 that discharges droplets is arranged in the sheet conveyance direction Y. In other words, the multiple nozzles 69 is arranged in a direction orthogonal to or intersecting with the moving direction Z of the carriage 62. Here, in the serial-type head unit 60, droplets are discharged from the nozzles 69 when the carriage 62 moves in the main scanning direction Z. Therefore, a relative movement direction in which the sheet S and the nozzles 69 move relative to each other during droplet discharge coincides with a reciprocating direction Z of the carriage 62. Therefore, when the “first direction” is defined as the nozzle array direction X, and the “second direction” is defined as the relative movement direction Z in which the sheet S and the nozzles 69 move relative to each other during droplet discharge, the “first direction” is orthogonal to or intersecting with the “second direction”.

As described above, application of the present disclosure to the serial-type head unit 60, in which the “first direction” and the “second direction” are orthogonal to or intersecting with each other, also makes it possible to effectively prevent a position where a droplet is applied from being shifted in the nozzle array direction X. Thus, it is possible to improve accuracy of causing the droplet 10 to be applied to a desired position.

That is, as a result of disposing, as in FIG. 6, the gas-discharge port 70 between the multiple nozzles 69 arranged in the nozzle array direction X (first direction) also in the serial-type head unit 60, it is possible to effectively prevent the position where the droplet 10 is applied from being shifted in the nozzle array direction X by means of the gas 8 discharged from each gas-discharge port 70. Furthermore, as in the first embodiment of the present disclosure, the gas-discharge port 70 may be disposed on the outer side of each of the nozzles 30 at both ends as well as between the nozzles 69.

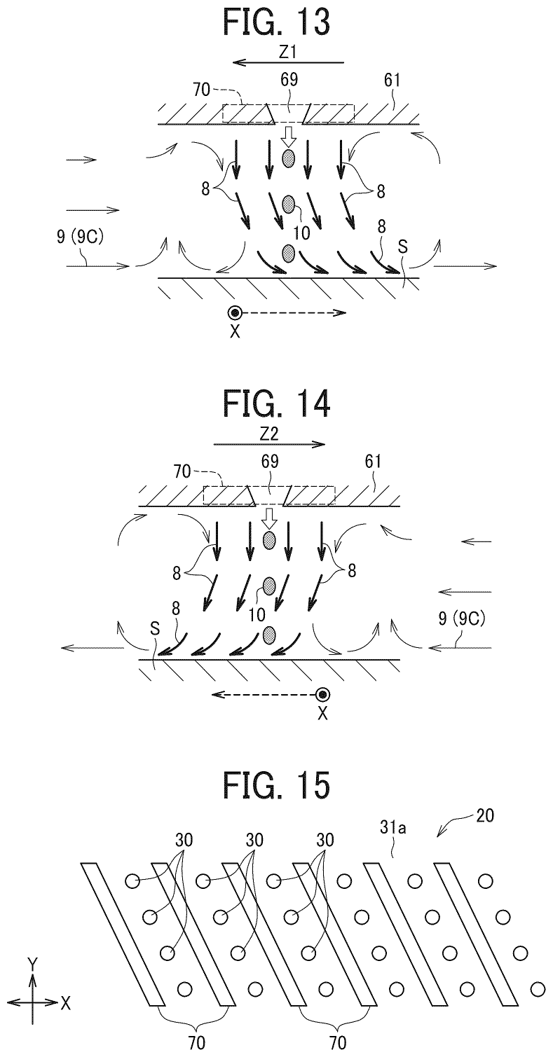

In the case of the serial-type head unit, the gas-discharge port 70 preferably extends from the position of the nozzle 30 to both the positive side and the negative side in the reciprocating direction Z (second direction) of the liquid discharge head 61 as illustrated in FIG. 12 when the gas-discharge port 70 is viewed from the nozzle array direction X. Since the gas-discharge port 70 extends to both the positive side and the negative side in this manner, the gas 8 is jetted from the upstream side (left side in the drawing) of the position of the nozzle 69 in the relative movement direction of the sheet S (broken-line arrow direction) in a case where, for example, the liquid discharge head 61 moves in one direction Z1 as illustrated in FIG. 13. This is because the relative movement direction in which the sheet S moves relative to the nozzles 69 coincides with the broken-line arrow direction in the drawing opposite to the direction Z1 in which the liquid discharge head 61 moves. In contrast, when the liquid discharge head 61 moves in an opposite direction Z2 as illustrated in FIG. 14, the gas 8 is jetted from the upstream side (right side in the drawing) of the position of the nozzle 69 in the relative movement direction of the sheet S indicated by a broken line arrow in the drawing. As described above, since the gas-discharge port 70 extends from the position of the nozzle 69 to the positive side and the negative side in the relative movement direction (second direction) of the sheet S, the gas 8 can be jetted from the upstream side of the nozzle 69 on both a forward path and a backward path in the reciprocation of the liquid discharge head 61. As a result, the effect of preventing a position where a droplet is applied from being shifted in the nozzle array direction X is achieved by the gas 8 jetted from the upstream side. Thus, it is possible to improve accuracy of causing the droplet 10 to be applied to a desired position even in the serial-type head unit 60.

Furthermore, as illustrated in FIG. 15, the nozzles 30 may be arranged such that the nozzles 30 are aligned in both the sheet conveyance direction Y (second direction) and the direction intersecting with the sheet conveyance direction Y. Even in such an example, by providing the gas-discharge port 70 between the multiple nozzles 30 arranged in the direction (direction of arrow X in the drawing) intersecting with the sheet conveyance direction Y, it is possible to effectively prevent the position where the droplet 10 is applied from being shifted in the nozzle array direction X (first direction), as in the above-described embodiments of the present disclosure.

The liquid discharge head and the head unit according to the present disclosure can be applied not only to the image forming apparatus cited as an example of the liquid discharge apparatus, but also to other liquid discharge apparatuses.

For example, the liquid discharge head and the head unit according to the present disclosure can also be applied to an electrode and electrochemical element manufacturing apparatus for manufacturing an electrode by discharging a liquid composition. That is, the “liquid discharge apparatus” according to the present disclosure includes not only an image forming apparatus that forms an image on a sheet but also an electrode and electrochemical element manufacturing apparatus. An electrode manufacturing apparatus is described below.

### Electrode Manufacturing Apparatus

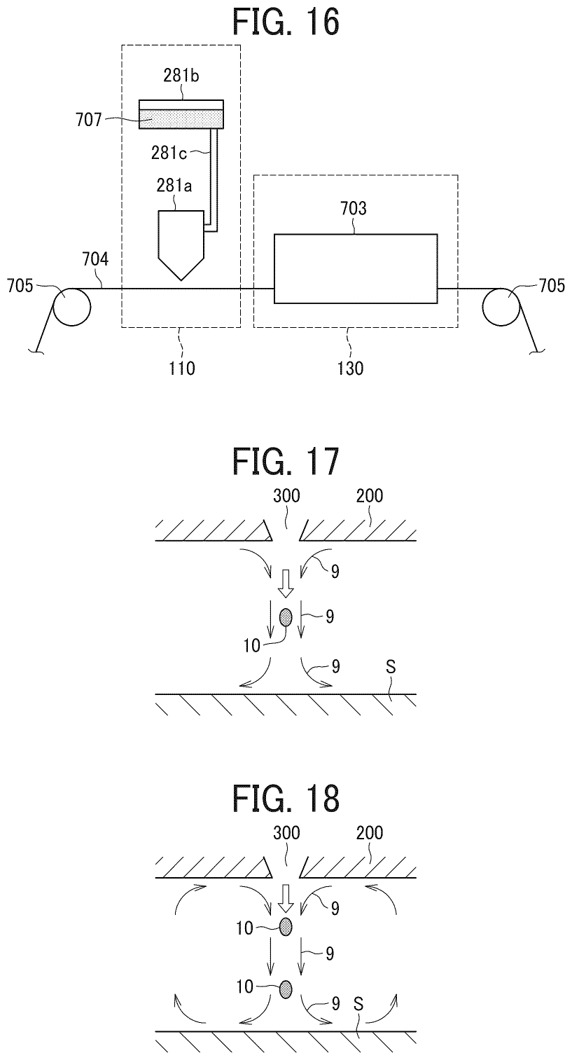

FIG. 16 is a schematic diagram illustrating an exemplary electrode manufacturing apparatus according to an embodiment of the present disclosure.

The electrode manufacturing apparatus illustrated in FIG. 16 is an apparatus for manufacturing an electrode including a layer containing an electrode material by discharging a liquid composition by means of a head unit including a liquid discharge head.

Unit for Forming Layer Containing Electrode Material and Process of Forming Layer Containing Electrode Material

A discharging unit included in the electrode manufacturing apparatus illustrated in FIG. 16 includes a head unit with the same configuration as the head units according to the above-described embodiments of the present disclosure. However, the liquid discharge head provided in the head unit discharges not ink but a liquid composition for manufacturing an electrode. When the liquid composition is discharged from the liquid discharge head onto a target object, a liquid composition layer is formed. The target object (hereinafter, may be referred to as “discharge target”) is not particularly limited, and may be appropriately selected depending on the intended purpose as long as the target object is an object on which a layer containing an electrode material is to be formed. Examples of the target object include an electrode substrate (current collector), an active material layer, and a layer containing a solid electrode material. The target object may be an electrode mixture layer containing an active material on an electrode substrate (current collector). The discharging unit and the discharging process may be a unit and a process of forming a layer containing an electrode material by directly discharging a liquid composition as long as the layer containing an electrode material can be formed on a discharge target (target object). The discharging unit and the discharging process may be a unit and a process of forming a layer containing an electrode material by indirectly discharging a liquid composition.

### Other Configurations and Other Processes

Other configurations included in the apparatus for manufacturing an electrode mixture layer are not particularly limited and may be appropriately selected depending on the intended purpose as long as the effects of the present disclosure are not impaired. Other processes included in the method for manufacturing an electrode mixture layer are not particularly limited and may be appropriately selected depending on the intended purpose as long as the effects of the present disclosure are not impaired. For example, a heating unit and a heating process can be cited as examples of the configuration and the process included in the apparatus and method for manufacturing an electrode mixture layer.

### Heating Unit and Heating Process

The heating unit included in the apparatus for manufacturing an electrode mixture layer is a unit that heats the liquid composition discharged by the discharging unit. The heating process included in the method for manufacturing an electrode mixture layer is a process of heating the liquid composition discharged in the discharging process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus for forming an electrode mixture layer containing an active material on an electrode substrate (current collector) is described below. As illustrated in FIG. 16, the electrode manufacturing apparatus includes a discharge process unit 110 and a heating process unit 130. The discharge process unit 110 performs a step of applying a liquid composition onto a printing base material 704 having a discharge target to form a liquid composition layer. The heating process unit 130 performs a heating process of heating the liquid composition layer to obtain an electrode mixture layer.

The electrode manufacturing apparatus includes a conveyor 705 that conveys the printing base material 704. The conveyor 705 conveys the printing base material 704 to the discharge process unit 110 and the heating process unit 130 in this order at a preset speed. A method for manufacturing the printing base material 704 having the discharge target such as an active material layer is not particularly limited, and a known method can be appropriately selected. The discharge process unit 110 includes a liquid discharge head 281a that performs an application process of applying the liquid composition onto the printing base material 704, a storage container 281b that stores a liquid composition 707, and a supply tube 281c that supplies the liquid composition 707 stored in the storage container 281b to the liquid discharge head 281a.

The discharge process unit 110 discharges the liquid composition 707 from the liquid discharge head 281a so that the liquid composition 707 is applied onto the printing base material 704 to form a liquid composition layer in a thin film shape. The storage container 281b may be integrated with the apparatus for manufacturing an electrode mixture layer, or may be detachable from the apparatus for manufacturing an electrode mixture layer. The storage container 281b may be used as a container to be added to a storage container integrated with the apparatus for manufacturing an electrode mixture layer or to a storage container detachable from the apparatus for manufacturing an electrode mixture layer.

The storage container 281b and the supply tube 281c can be selected in a desired manner as long as the liquid composition 707 can be stably stored and supplied to the liquid discharge head 281a.

The heating process unit 130 performs a solvent removal process of heating and removing the solvent remaining in the liquid composition layer. Specifically, the solvent remaining in the liquid composition layer is heated and dried by a heating device 703 of the heating process unit 130, and thus the solvent is removed from the liquid composition layer. Thus, the electrode mixture layer is formed. The solvent removal process may be performed in the heating process unit 130 under reduced pressure.

The heating device 703 is not particularly limited and may be appropriately selected depending on the intended purpose. Examples of the heating device 703 include a substrate heater, an infrared (IR) heater, and a hot air heater. The heating device 703 may be a combination of at least two of the substrate heater, the IR heater, and the hot air heater. A heating temperature and heating time can be appropriately selected according to a boiling point of the solvent contained in the liquid composition 707 or the thickness of a formed film.

Use of the electrode manufacturing apparatus according to the embodiment of the present disclosure enables a liquid composition to be discharged onto a desired point on a discharge target. The electrode mixture layer can be suitably used as, for example, a part of the configuration of an electrochemical element. The configuration of the electrochemical element other than the electrode mixture layer is not particularly limited, and a known configuration can be appropriately selected. For example, as a configuration other than the electrode mixture layer, the electrochemical element may include a positive electrode, a negative electrode, and a separator.

The sheet to be used in the present disclosure is a sheet to which liquid can adhere at least temporarily, and may be a sheet to which liquid adheres and sticks, or a sheet to be permeated by liquid that adheres thereto. Specifically, examples of the sheet include a resin film, wallpaper, and an electronic substrate as well as a paper sheet. Examples of the material of the sheet include paper, leather, metal, plastic, glass, wood, and ceramics. The sheet is not limited to a long sheet continuously conveyed without interruption from the sheet feeding unit to the sheet collection unit, and may be a short sheet independently conveyed one by one without being continuously conveyed from the sheet feeding unit to the sheet collection unit.

The liquid to be applied to the sheet is not particularly limited, and examples thereof include solutions, suspensions, and emulsions containing water, solvents such as organic solvents, colorants such as dyes and pigments, function-imparting materials such as polymerizable compounds, resins, and surfactants, biocompatible materials such as deoxyribonucleic acid (DNA), amino acids, proteins, and calcium, edible materials such as natural pigments, and the like. Such a solution, a suspension, or an emulsion can be used for, e.g., inkjet ink, a surface treatment solution, a liquid for forming components of an electronic element or light-emitting element or a resist pattern of an electronic circuit, or a material solution for three-dimensional fabrication.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

A liquid discharge head includes multiple nozzles arrayed in a first direction, the multiple nozzles to discharge droplets in a discharge direction onto a medium conveyed in a second direction intersecting the first direction, and a gas-discharge port between the multiple nozzles adjacent to each other in the first direction, the gas-discharge port to discharge gas.

The liquid discharge head includes another gas-discharge port outside an outermost nozzle of the multiple nozzles in the first direction. The liquid discharge head includes multiple gas-discharge ports including the gas-discharge port, and at least one of the multiple gas-discharge ports is at each portion between the multiple nozzles adjacent to each other in the first direction.

The gas-discharge port extends in the second direction. The gas-discharge port discharges the gas in a direction inclined toward a downstream side of the gas-discharge port in the second direction relative to the discharge direction. The gas-discharge port extends in at least one of a downstream side and an upstream side from one of positions of the multiple nozzles in the second direction. The gas-discharge port extends in both a downstream side and an upstream side from one of positions of the multiple nozzles in the second direction.

The liquid discharge head discharges the gas from the gas-discharge port at an average speed of 4 m/s or more and 12 m/s or less in the discharge direction. A head unit includes multiple liquid discharge heads including the liquid discharge head. A liquid discharge apparatus includes the liquid discharge head.

The liquid discharge head includes multiple gas-discharge ports including the another gas-discharge port, and the multiple gas-discharge ports are disposed outside the outermost nozzle of the multiple nozzles in the first direction. The liquid discharge head includes multiple gas-discharge ports including the another gas-discharge port, and the multiple gas-discharge ports are outside the outermost nozzle of the multiple nozzles in the first direction, and arrayed along the first direction.

The gas-discharge port has a length larger than a diameter of each of the multiple nozzles in the second direction. The liquid discharge apparatus includes the liquid discharge head, and the liquid discharge head constantly discharges the gas from the gas-discharge port while discharging the droplets from the multiple nozzles.

The liquid discharge apparatus according to claim 10, includes the liquid discharge head, and the liquid discharge head discharges the droplets from the multiple nozzles at a first average speed in the discharge direction, and discharges the gas from the gas-discharge port in the discharge direction at a second average speed within a range of the first average speed minus 20% to the first average speed plus 20%.

According to the present disclosure, it is possible to effectively prevent a position where a droplet is applied from being shifted in the nozzle array direction (first direction). To summarize the aspects of the present disclosure described above, the present disclosure includes at least the following aspects.

### Aspect 1

According to Aspect 1, a liquid discharge head includes multiple nozzles that discharges droplets onto a sheet, wherein a first direction and a second direction intersect with each other when the first direction is defined as a direction in which the multiple nozzles is arranged and the second direction is defined as a relative movement direction in which the sheet and the nozzles move relative to each other during droplet discharge, and at least one gas-discharge port is provided between the multiple nozzles arranged in the first direction, gas being to be discharged from the gas-discharge port.

### Aspect 2

According to Aspect 2, in the liquid discharge head of Aspect 1, the gas-discharge port is disposed on an outer side of an outermost nozzle in the first direction as well as between the multiple nozzles arranged in the first direction, the outermost nozzle being one of the multiple nozzles.

### Aspect 3

According to Aspect 3, in the liquid discharge head of Aspect 1 or 2, the gas-discharge port is disposed between all the multiple nozzles arranged in the first direction.

### Aspect 4

According to Aspect 4, in the liquid discharge head of any one of Aspects 1 to 3, the gas-discharge port extends upstream from a position of the nozzle in the relative movement direction of the sheet.

### Aspect 5

According to Aspect 5, in the liquid discharge head of Aspect 4, a gas discharge direction in which gas is discharged from the gas-discharge port is inclined toward a downstream side in the relative movement direction of the sheet with respect to a discharge direction in which a droplet is discharged from the nozzle.

### Aspect 6

According to Aspect 6, in the liquid discharge head of any one of Aspects 1 to 3, the gas-discharge port extends to at least one of a positive side and a negative side from a position of the nozzle in the second direction.

### Aspect 7

According to Aspect 7, in the liquid discharge head of any one of Aspects 1 to 3, the gas-discharge port extends to both a positive side and a negative side from a position of the nozzle in the second direction.

### Aspect 8

According to Aspect 8, in the liquid discharge head of any one of Aspects 1 to 7, gas is discharged from the gas-discharge port in a gas discharge direction at an average speed of 4 m/s or more and 12 m/s or less.

### Aspect 9

According to Aspect 9, a head unit includes the liquid discharge head of any one of Aspects 1 to 8, wherein the liquid discharge head includes a plurality of liquid discharge heads.

### Aspect 10

According to Aspect 10, a liquid discharge apparatus includes the liquid discharge head of any one of Aspects 1 to 8 or the head unit of Aspect 9.

### Aspect 11

According to Aspect 11, in the liquid discharge head of Aspect 2, the gas-discharge port disposed on the outer side of the outermost nozzle in the first direction includes a multiple gas-discharge ports.

### Aspect 12

According to Aspect 12, in the liquid discharge head of Aspect 2, the gas-discharge port disposed on the outer side of the outermost nozzle in the first direction includes a multiple gas-discharge ports provided along the first direction.

### Aspect 13

According to Aspect 13, in the liquid discharge head of Aspect 1, the gas-discharge port has a length larger than a diameter of the nozzle in the relative movement direction of the sheet.

### Aspect 14

According to Aspect 14, in the liquid discharge apparatus of Aspect 10 including the liquid discharge head of Aspect 1, gas is constantly discharged from the gas-discharge port when a droplet is discharged from the nozzle.

### Aspect 15

According to Aspect 15, in the liquid discharge apparatus of Aspect 10 including the liquid discharge head of Aspect 1, an average speed at which gas is discharged from the gas-discharge port in a gas discharge direction falls within a range of plus or minus 20% of an average speed at which a droplet is discharged from the nozzle.

1. A liquid discharge head comprising:
multiple nozzles arrayed in a first direction, the multiple nozzles to discharge droplets in a discharge direction onto a medium conveyed in a second direction intersecting the first direction; and
a gas-discharge port between the multiple nozzles adjacent to each other in the first direction, the gas-discharge port to discharge gas.

2. The liquid discharge head according to claim 1, further comprising another gas-discharge port outside an outermost nozzle of the multiple nozzles in the first direction.

3. The liquid discharge head according to claim 1, further comprises multiple gas-discharge ports including the gas-discharge port,
wherein at least one of the multiple gas-discharge ports is at each portion between the multiple nozzles adjacent to each other in the first direction.

4. The liquid discharge head according to claim 1,
wherein the gas-discharge port extends in the second direction.

5. The liquid discharge head according to claim 4,
wherein the gas-discharge port discharges the gas in a direction inclined toward a downstream side of the gas-discharge port in the second direction relative to the discharge direction.

6. The liquid discharge head according to claim 1,
wherein the gas-discharge port extends in at least one of a downstream side and an upstream side from one of positions of the multiple nozzles in the second direction.

7. The liquid discharge head according to claim 1,
wherein the gas-discharge port extends in both a downstream side and an upstream side from one of positions of the multiple nozzles in the second direction.

8. The liquid discharge head according to claim 1,
wherein the liquid discharge head discharges the gas from the gas-discharge port at an average speed of 4 m/s or more and 12 m/s or less in the discharge direction.

9. A head unit comprising multiple liquid discharge heads including the liquid discharge head according to claim 1.

10. A liquid discharge apparatus comprising the liquid discharge head according to claim 1.

11. The liquid discharge head according to claim 2, further comprising multiple gas-discharge ports including the another gas-discharge port,
wherein the multiple gas-discharge ports are disposed outside the outermost nozzle of the multiple nozzles in the first direction.

12. The liquid discharge head according to claim 2, further comprising multiple gas-discharge ports including the another gas-discharge port,
wherein the multiple gas-discharge ports are:
outside the outermost nozzle of the multiple nozzles in the first direction; and
arrayed along the first direction.

13. The liquid discharge head according to claim 1,
wherein the gas-discharge port has a length larger than a diameter of each of the multiple nozzles in the second direction.

14. The liquid discharge apparatus according to claim 10, wherein:
the liquid discharge head constantly discharges the gas from the gas-discharge port while discharging the droplets from the multiple nozzles.

15. The liquid discharge apparatus according to claim 10, wherein the liquid discharge head:
discharges the droplets from the multiple nozzles at a first average speed in the discharge direction; and
discharges the gas from the gas-discharge port in the discharge direction at a second average speed within a range of the first average speed minus 20% to the first average speed plus 20%.
